(19) United States
(12) Patent Application Publication
(10) Pub. No.: US 2007/0192690 A1
(43) Pub. Date: Aug. 16, 2007

(54) METHOD AND SYSTEM FOR FRAMING AND EVALUATING A DECISION MAKING PROCESS

(76) Inventor: Bart Huthwaite SR., Mackinac Island, MI (US)

Correspondence Address: BARLOW, JOSEPHS & HOLMES, LTD., 101 DYER STREET, 5TH FLOOR, PROVIDENCE, RI, 02903, US

(21) Appl. No.: 11/621,430

(22) Filed: Jan. 9, 2007

Related U.S. Application Data
(60) Provisional application No. 60/757,689, filed on Jan. 10, 2006.

(51) Int. Cl. G06F 3/00; G06T 15/00; G09B 19/18

(52) U.S. Cl. 715/700; 345/419; 434/107

(57) ABSTRACT

A system and device are provided to facilitate visualization and structuring of a multi-variable evaluative process such as an innovation and decision-making process. The standardized process frames the problem in a three dimensional fashion having an x, y and z-axis. The present invention employs a visualization device that preferably takes the form of a six-sided cube. The use of a cube allows the user to orient the cube in a manner that allows framing of the problem to be solved in a manner that creates a visual structure and a framework that is employed by the user with consistency. The method and system is also well suited for implementation via a computer-based model that employs the same visualizations and standardized innovation process.

### CROSS-REFERENCE TO RELATED APPLICATIONS

This application is related to and claims priority from earlier filed U.S. Provisional Patent Application No. 60/757,689, filed Jan. 10, 2006, the contents of which are incorporated herein by reference.

### BACKGROUND OF THE INVENTION

The present invention relates generally to a method for assisting a user in the evaluation of a complex and multi-variable innovation, discovery and decision making process in a manner that replicates the natural process of innovation thereby making the process understandable, systematic and repeatable. More specifically, the present invention relates to a new method and device that provides visualization tools to a user to assist and guide them in framing and evaluating a complex and multi-variable innovation related decision-making process in an ordered and organized fashion.

Businesses are always seeking to quickly and effectively innovate in order to accelerate growth and bottom line profit. In this regard, businesses have historically attempted to enable their employees and members to think creatively and innovatively, to be able to communicate ideas, to accept change and to have good team skills. In the past, consultants that attempt to improve the innovation flow within a business organization first attempt to “team build” based on the premise that with better team spirit, communication between team members will improve therefore improving the flow of innovation. Typically, these consultants have used different forms and exercises to enhance these attributes. The difficulty that is typically encountered results from the fact that these exercises are usually purely psychological or sociological encounter sessions, or game-like activities employing a physical challenge component.

In the prior art there are numerous game-like physical challenges that are well known. For example, a challenge may be laid out as an obstacle course wherein a team must think quickly, act together as a single unit and assist each other through difficult sections of the course. Obstacle courses also draw upon the team's creativity when attempting to negotiate particularly difficult sections, such as high walls or moats. By completing such a course, participants often experience a strong sense of accomplishment and a heightened sense of confidence, which may translate to the work environment in their willingness to take on and solve difficult problems as a team. Importantly, these exercises also identify those individuals who have difficulty working in a team environment.

Similarly, another physical activity related team building educational system that is well known is an activity wherein portable props such as planks, ropes and the like are utilized for the construction of a challenging course. This course forms a part of what is described as adventure-based education, often referred to as a “ropes course”, and is typically a set of events or problem-solving activities designed to teach team building, trust, problem solving, leadership, and individual initiative and creativity.

While these type activities are well suited for fostering closeness and a team spirit among the various employees, they are simply socialization events that do not serve to further develop the goals of the business in terms of developing or forwarding the innovation process. In terms of innovation, most businesses ultimately rely on random brainstorming and the need to make such innovation decisions in a “seat of the pants” manner.

In the psychological or sociological area, there are numerous visualization techniques that have been developed to assist management in streamlining and standardizing evaluation processes. For example, US Publication No. 2006/0015380 discloses generally the process of business management and then goes on to create a specific framework via a three pronged evaluative process. Each of the prongs of the process is directed toward an aspect of the business lifecycle including “Customer Lifecycle Management”, “Supply Chain Management” and “Product Lifecycle Management”. Similarly, U.S. Pat. No. 6,756,983 provides a visualization method that employs rotating display wheels wherein each of the wheels represents a functional portion of a business. Each of the wheels is divided into segments that represent the various processes within the functional portion of the business that the wheel represents. Finally, a communication pathway extends through the center of all of the wheels. In addition, U.S. Pat. No. 5,927,987 employs an interactive visualization system that uses a deck of concept cards that are visually enhanced and include business related principles in a categorized manner. Principally this system is intended for education use.

One interesting visualization technique in the prior art is revealed in U.S. Pat. No. 7,114,719, which discloses an educational and training process that employs visualization polygons for segmenting and controlling various decision making processes in the business environment. In the preferred embodiment, the process is implemented using cubes. The cubes are configured to be nested within each other and have corresponding faces that when stacked together illustrate the various layers of each of the processes depicted on the faces thereof.

The problem with all of the prior art visualization techniques is that they essentially serve only to establish a graphic representation of a stepwise flowchart that is presented for the user to step through. While these prior art visualization devices work in standard decision making processes wherein a handful of potential end results are already known and the user simply needs a visualization tool to assist in picking between one of the known outcomes, they are simply not helpful in assisting a user to proceed through a multivariable analysis in a logical stepwise manner where the outcome is not yet known and is likely to be novel (an innovation).

Accordingly, there is a need for a system whereby a multi-variable problem solving and innovation process is formalized and structured using empirical and comparative based solution sets. There is a further need for a structured system of innovation that provides a visual and structured guide to assist a user through the entire process.

### BRIEF SUMMARY OF THE INVENTION

In accordance with the present invention a novel system and device are provided to facilitate visualization and structuring of a multi-variable evaluative process such as an innovation and decision-making processes. In general, the standardized process is framed in a three dimensional fashion having an x, y and z-axis. In order to assist the user in framing the axes the present invention employs a visualization device that preferably takes the form of a six-sided cube.

In utilizing the process of the present invention, the use of a cube as a visualization device allows the user to orient the cube in a manner that allows framing of the problem to be solved in a structured three-axis manner that creates a visual structure and a framed innovation process that is employed by the user with consistency. Further, while the process in illustrated in terms of a paper based cube visualization device, the present invention is also well suited for implementation via a computer based model that employs the same visualizations and standardized innovation process while also allowing the experience to be interactive for the user.

In operation the user orients the visualization device by orienting themselves along two axes of the device (the x and y axes) using known information and then works upwardly along the axes with which they are oriented (in the direction of the z axis) to create a solution set based on the intersection of the orientation axes. In the context of the cube visualization device, the user orients themselves using two faces and then utilizes the intersection of the oriented faces to solve upwardly along the edge to reach a solution set generally embodied by the top face that is reached by following the intersecting edge.

It is therefore an object of the present invention is to broaden creative thinking and problem solving. A further object of the present invention is to improve individual and team innovation through a standardized and repeatable visual process. It is still a further object of the present invention to provide a visualization device that allows a user to visually move stepwise through a standardized innovation process in a manner that focuses and streamlines the innovation process.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a graphic representation of the three-axis problem-solving framework of the present invention;

FIG. 2 is a schematic diagram depicting the application of the method and system of the present invention;

FIG. 3 is a flattened view of a cube device for implementation of the method and system of the present invention;

FIG. 3A is a view of the cube device aligned with the three axis framework; and

FIG. 4 is a flowchart depicting the operation of the principals of the method and system of the present invention for the purpose of virtual implementation.

### DETAILED DESCRIPTION OF THE INVENTION

Now referring to the drawings, the method and system for framing and evaluating information is shown and generally illustrated in the figures. In accordance with the present invention a method and system is provided to facilitate visualization and structuring of a multi-variable evaluative process such as an innovation and decision-making processes. In general, the standardized process is framed in a three-dimensional fashion having an x, y and z-axis.

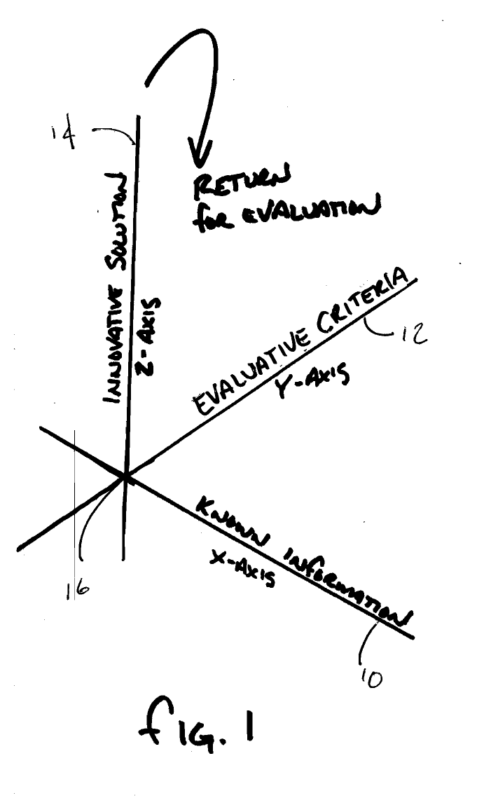

Turning now to FIG. 1, an illustration is provided that schematically illustrates the framework for structuring the data in accordance with the present invention, wherein the framework includes an x-axis 10, a y-axis 12 and a z-axis 14. Each of the three axes 10, 12, 14 intersects at a single point 16 in three-dimensional space and are all arranged orthogonally at 900 relative to one another. Given this framework, the baseline information or known information to be evaluated is arranged to reside along the x-axis 10. The evaluative criterion that is to be used for the structured analysis of the baseline information is arranged in a similar fashion along the y-axis 12. With the baseline information and the evaluative criteria structured in this manner, a user then evaluates the baseline information through the lenses of the evaluative criteria to identify any commonality between the baseline information on the x-axis 10 and the criterion on the y-axis 12. It is this commonality that is then employed by the user to create a solution set of information that is then disposed along the z-axis 16. It is this solution set that provides the user with the predictive information upon which an innovative solution can be based.

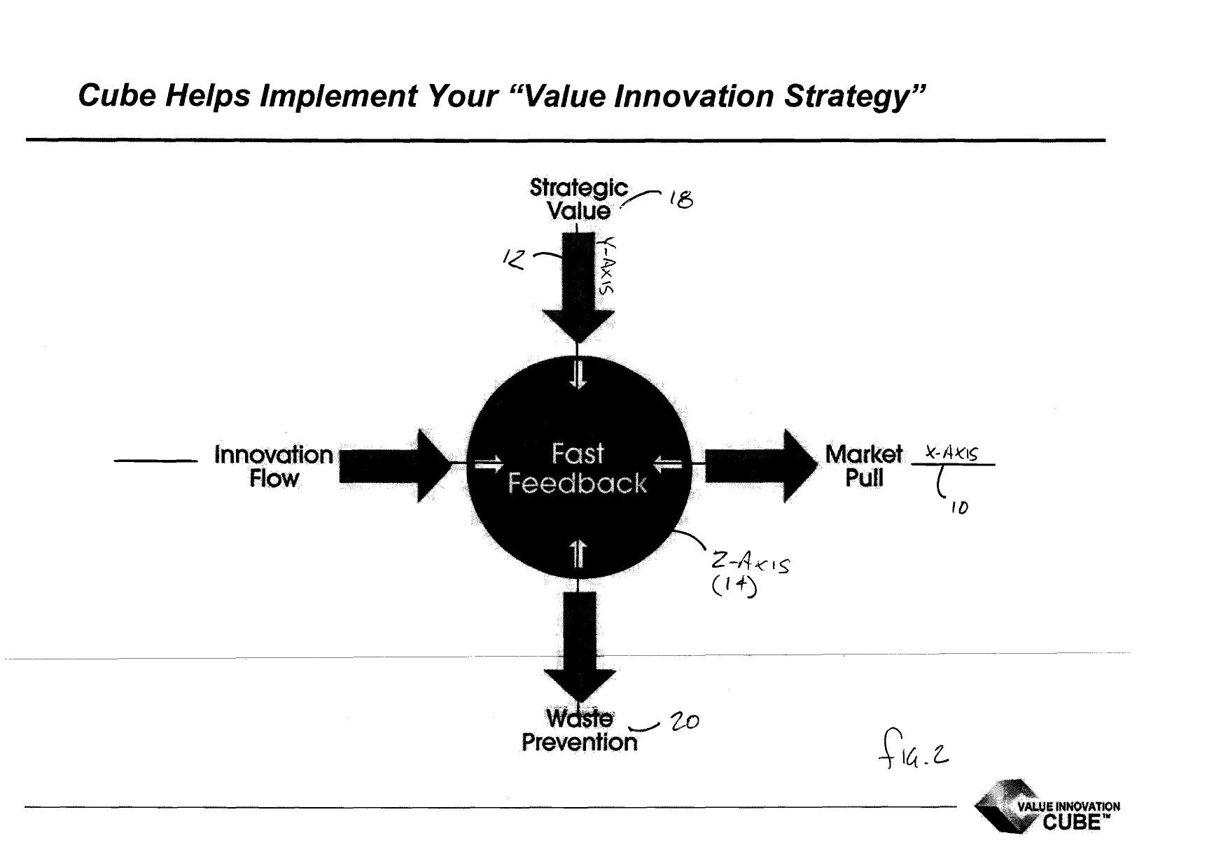

Turning now to FIG. 2, a more refined picture that represents application of actual concepts is presented. In essence, the x-axis 10 in this picture runs through the figure from left to right while the y-axis 12 runs vertically and the z-axis 14 extends out of the page in a perpendicular fashion and is represented by the large circle in the center of the figure. As is suggested by the figure, the innovation flow must extend and move along the x-axis 10, as this is where all of the known information resides. The evaluative criteria in the form of strategic value and improved efficiency or the broader category of waste prevention is applied to the known information along the y-axis 12 and the user generates solution sets, further evaluations and ultimately innovation feed back that extends along the z-axis 14.

With the known information arranged on the x-axis 10, a structured set of evaluative criteria is arranged along the y-axis 12. A first set of evaluative criteria 18 identified as value additive criteria is arranged along the y-axis 12 in a first direction and a second set of evaluative criteria 20 identified as value detracting criteria are arranged in a second direction along the y-axis 12. In one example, the value additive criteria 18 may be core customer values while the value detracting criteria 20 may be waste generating features. By arranging the evaluative criteria 18, 20 in such a manner, the user is given a structured framework that is easily followed and repeatable in subsequent evaluations thereby insuring a fair comparison for each process that is evaluated.

Within the framework then, the evaluative process of developing solution sets includes developing a solution set in a first direction along the z-axis 14 to identify new values presented within the solution set and in a second direction along the z-axis 14 to apply evaluation criteria to the proposed solution set to provide an objective evaluation that facilitates comparison to the original baseline information. Once a solution set is identified and fully developed, the solution set can be put back into the evaluative system of the present invention whereby the evaluation process is repeated to further develop the solution set and identify other latent opportunities presented therein.

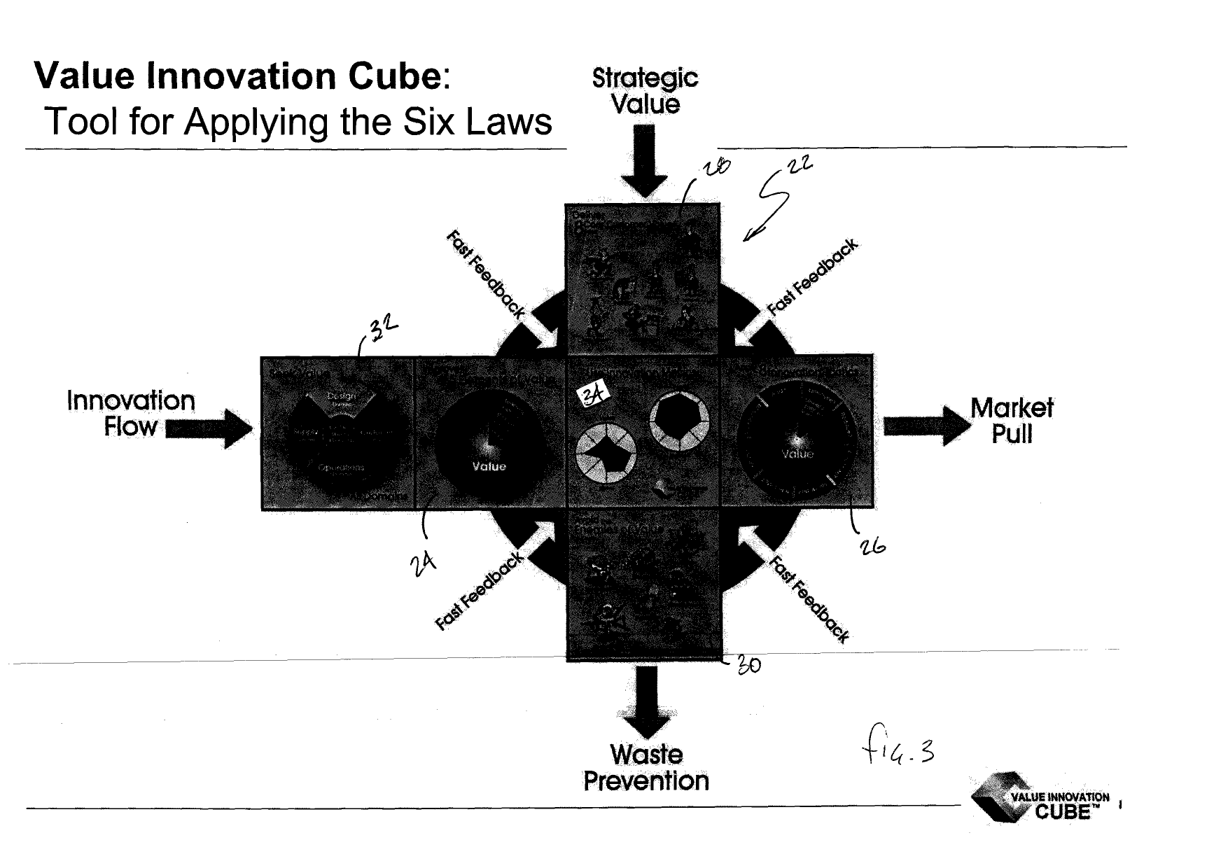

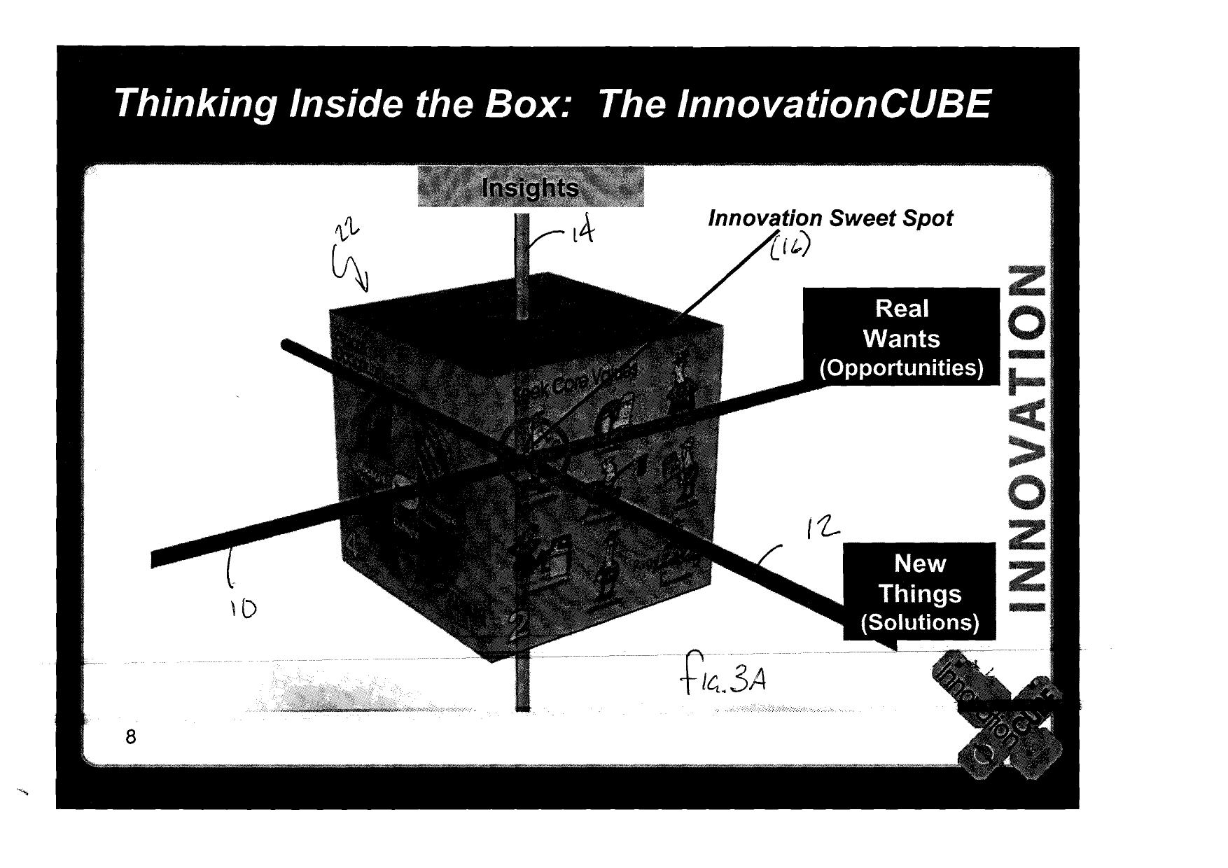

Turning now to FIGS. 3 and 3A, a physical three-dimensional framework to assist a user in visualizing the process is shown and depicted as a cube 22 such that said intersection 16 of said x-axis 10, y-axis 12 and z-axis 14 lies at the center of said cube 22 and each of said axes 10, 12, 14 extends outwardly through two opposing faces of said cube 22. In other words, each of the x 10, y 12 and z-axes 14 extend in a first direction through one face and in a second direction through the opposing face of the cube 22, thereby giving the user a useful reference tool that provides assistance in framing the problem to be solved. It should be appreciated that while the cube 22 in FIG. 3 is shown in a flattened arrangement, the six faces are disposed and arranged to be folded and assembled into a cube 22 device.

In operation once the cube 22 is assembled, the user structures the problem to be solved by entering the cube 22 along an x-axis 10 that is disposed to coincide with the face directed to improving the elements of value 24 and application of innovation tactics 26. In this regard a user calibrates the innovative undertaking that they desire to implement. The user focuses the goals, identifies all of the stakeholders and determines the boundaries and hurdles that will be faced in the process.

Adjacent the calibration sides 24, 26 lying along the x-axis 10 of the cube 22 can be seen two balanced and opposing sides 28, 30 that lie along the y-axis 12, one side representing ways to deliver new value 28 and the opposing side representing the enemies of value 30. These sides 28, 30 of the cube 22 are placed in a manner that provides a standardized listing and reference of the core values that all customers seek for the purpose of evaluating the delivery performance of a product, service or business system. This allows the now identified innovative undertaking that is placed along the x-axis 10 to be examined through a value-creating lens using one side 28 while the opposing side 30 serves as a balance point wherein a user can also identify enemies of value that should be reduced or eliminated as the innovative process progresses forward.

The remaining sides 32, 34 of the cube 22 then provide for the identification of resources at the disposal of the innovative process upon which the process can be focused to systematically improve the process. It illustrates visually each of the key areas of resources wherein the innovation process should be utilized in a stepwise fashion to focus the innovation search. In essence it identifies each of the potential areas wherein improvements may lead to innovation. In addition an interface is provided for creating ideas to improve the “values” and reduce the “wastes” identified using the cube faces 28, 30 along the y-axis 12. This is done by using a series of eight “trigger questions” about each of the five resources identified. The visualization provides questions that need to be asked and applied to each of the identified resources to create new ideas directed at optimizing the values and minimizing the wastes thereby assisting the user in determining the correct answer in terms of the innovation process at hand. The objective of the top face 32 working upwardly along the z-axis 14 is to generate as many ideas as possible. Then, using the five resources as an architecture, these ideas are then grouped into sets of possible solutions. This provides a standardized matrix into which each and every resource in the process is evaluated in conjunction with the particular innovation process at hand to provide a systematic evaluation the generates a standardized and well considered outcome for implementation.

Finally, the bottom face 34 along the z-axis 14 provides a graphical side-by-side comparison of the solution sets so that the user can receive immediate feedback. The feedback is illustrated as a comparison between a current state baseline as compared to the results of the implementation of any of the given solutions developed through the use of the system to visually depict the efficacy of that solution versus the status quo. Similarly, various alternate solutions can also be compared against one another.

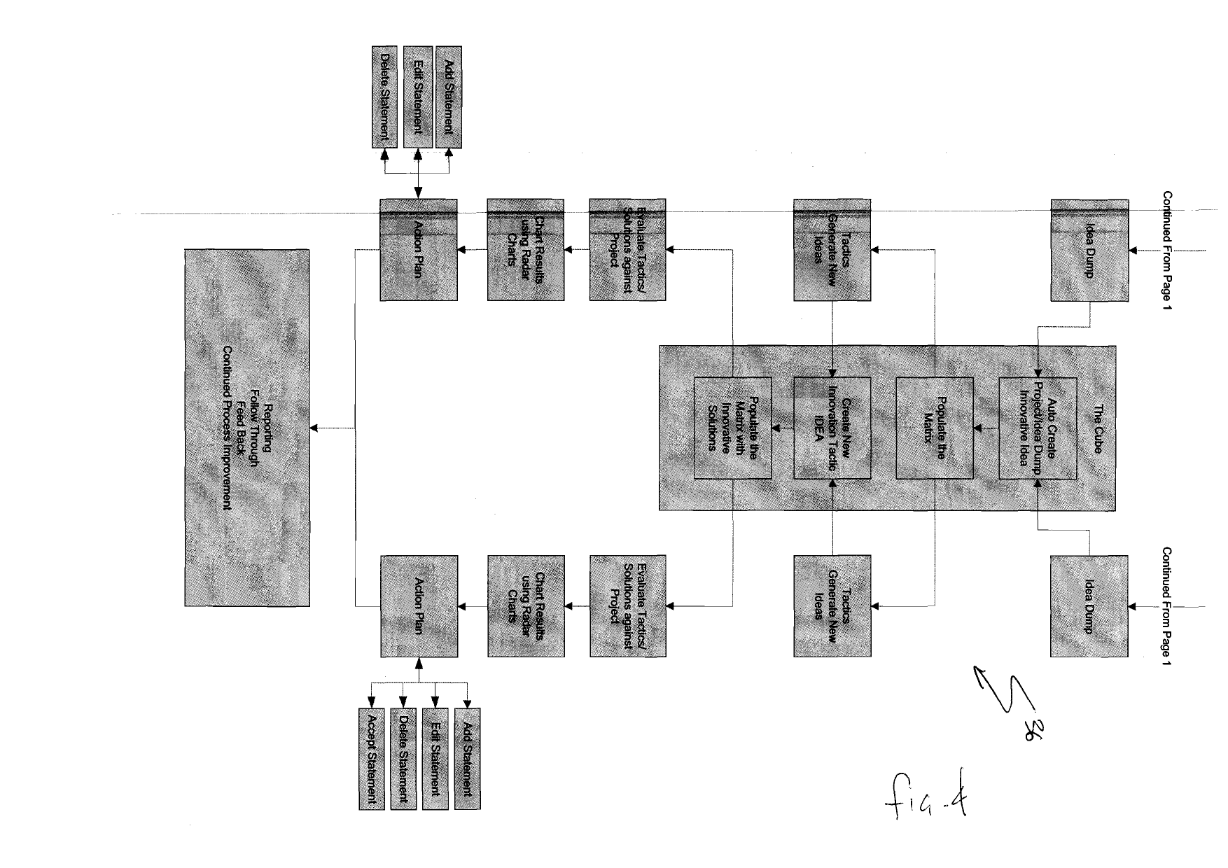

One skilled in the art should also appreciate that while the present method may be illustrated in the physical form of a cube 22, it is also possible to create the three-dimensional framework of the present invention in a virtual construct that is created within a virtual interface. For example, FIG. 4 depicts a flow chart 36 that provides a structure for replicating the problem framing and visualization method of the present invention in terms of a virtual interface. Essentially a user employs a virtual interface such as a computer to work through the various steps illustrated above by inputting the information into a virtual cube construct and working through the process of the present invention. It should also be appreciated that a user may employ a computer connected to an electronic communication network may access the virtual cube construct via the communication network such as across the world wide web.

It can therefore be seen that the present invention provides a method and system that facilitates visualization and structuring of a multi-variable evaluative process such as an innovation and decision-making processes in a standardized three-dimensional fashion having an x, y and z-axis. Further, the present invention can be seen to provide a structured process whereby a user can standardize the evaluation process thereby creating a repeatable process that facilitates reliable and comparable results each time the user works through the process. For these reasons, the present invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of structuring baseline information to assist a user in evaluating said baseline information for the purpose of identifying new value within said baseline information, comprising the steps of:
creating a three-dimensional framework having an x-axis, a y-axis and a z-axis, wherein all of said axes intersect at a single point and are all arranged three-dimensionally at 90° relative to one another;
sorting said baseline information to be evaluated and arranging it on said x-axis;
arranging structured evaluative criteria along said y-axis;
evaluating said baseline information along said x-axis using said structured evaluative criteria positioned along said y-axis to identify portions of said information along said x-axis and said y-axis that have commonality;
creating a solution set of information based on said commonality, said solution set lying along said z-axis; and
further developing said solution set.

2. The method of claim 1, further comprising:
repeating the evaluation process using said further developed solution set.

3. The method of claim 1, wherein said step of further developing said solution set further comprises:
developing said solution set in a first direction along said z-axis to identify new values presented within said solution set; and
developing said solution set in a second direction opposite said first along said z-axis to apply evaluation criteria to said solution set to provide an objective evaluation that facilitates comparison to said baseline information.

4. The method of claim 1, wherein said step of arranging structured evaluative criteria along said y-axis further comprises:
arranging value additive criteria in a first direction along said y-axis; and
arranging value-detracting criteria in a second direction opposite said first along said y-axis.

5. The method of claim 4, wherein said value additive criteria are considered core customer values.

6. The method of claim 4, wherein said value detracting criteria are considered waste generating features.

7. The method of claim 1, wherein said three-dimensional framework is represented by a cube such that said intersection of said x-axis, y-axis and z-axis lies at the center of said cube and each of said axes extends outwardly through two opposing faces of said cube.

8. The method of claim 1, wherein said three-dimensional framework is a virtual construct that is created within a virtual interface.

9. The method of claim 8, wherein said virtual interface is a computer.

10. The method of claim 8, wherein said virtual interface is accessible via an electronic communication network.

11. A graphical user interface for structuring baseline information to assist a user in evaluating said baseline information for the purpose of identifying new value within said baseline information, said interface comprising:
a three-dimensional framework having an x-axis, a y-axis and a z-axis, wherein all of said axes intersect at a single point and are all arranged three-dimensionally at 90° relative to one another,
wherein said baseline information to be evaluated is arranged on said x-axis, structured evaluative criteria is arranged along said y-axis and a solution set is generated to lie along said z-axis.

12. The graphical user interface of claim 11, wherein said user employs said baseline information along said x-axis and said structured evaluative criteria positioned along said y-axis to identify portions of said information along said x-axis and said y-axis that have commonality,
wherein said solution set of information is created based on said commonality.

13. The graphical user interface of claim 12, wherein a user can further develop said solution set by applying the evaluative criteria along said y-axis thereby creating a larger possible solution set along said z-axis.

14. The graphical user interface of claim 12, wherein a user can further develop said solution set by developing said solution set in a first direction along said z-axis to identify new values presented within said solution set, and
by developing said solution set in a second direction opposite said first along said z-axis to apply evaluation criteria to said solution set to provide an objective evaluation that facilitates comparison to said baseline information.

15. The graphical user interface of claim 11, wherein value additive criteria is provided in first direction along said y-axis and value detracting criteria is provided in a second direction opposite said first along said y-axis.

16. The graphical user interface of claim 15, wherein said value additive criteria are considered core customer values.

17. The graphical user interface of claim 15, wherein said value detracting criteria are considered waste generating features.

18. The graphical user interface of claim 11, wherein said three-dimensional framework is represented by a cube such that said intersection of said x-axis, y-axis and z-axis lies at the center of said cube and each of said axes extends outwardly through two opposing faces of said cube.

19. The graphical user interface of claim 11, wherein said three-dimensional framework is a virtual construct that is created within a virtual interface.

20. The graphical user interface of claim 19, wherein said virtual interface is a computer.

21. The graphical user interface of claim 19, wherein said virtual interface is accessible via an electronic communication network.
